(19) United States
(12) Patent Application Publication
(10) Pub. No.: US 2008/0091542 A1
(43) Pub. Date: Apr. 17, 2008

(54) Advertising intermediation server

(76) Inventors: Daryl David Coutts, Edmonton (CA); Stephen Harrison Johnston, Calgary (CA)

Correspondence Address: Daryl D. Coutts, Suite 207, 11103 84 Ave, Edmonton, AB, T6G 2X4, CA

(21) Appl. No.: 11/987,139

(22) Filed: Nov. 28, 2007

Related U.S. Application Data
(60) Provisional application No. 60/861,414, filed on Nov. 29, 2006.
(60) Provisional application No. 60/907,787, filed on Apr. 17, 2007.
(60) Provisional application No. 60/924,347, filed on May 10, 2007.
(60) Provisional application No. 60/924,575, filed on May 21, 2007.
(60) Provisional application No. 60/929,090, filed on Jun. 12, 2007.
(60) Provisional application No. 60/929,463, filed on Jun. 28, 2007.
(60) Provisional application No. 60/929,618, filed on Jul. 5, 2007.

(51) Int. Cl. G06Q 30/00

(52) U.S. Cl. 705/14

(57) ABSTRACT

An advertising system where user's are rewarded for having advertisements displayed on their computing devices is described. Advertisement and scheduling information is provided by a server to the computing devices. Rewards are accrued by the server on behalf of the users.

### CROSS REFERENCE TO RELATED APPLICATIONS

This application claims the benefit of priority under 35 USC 119(e) to U.S. Provisional Application No. 60/861,414, filed Nov. 29, 2006, entitled “SYSTEM FOR DELIVERING VIDEO ADS TO HANDHELD DEVICES”; U.S. Provisional Application No. 60/907,787, filed Apr. 17, 2007, entitled “METHODS AND SYSTEMS FOR PROMPTING USERS OF COMPUTING DEVICES”; U.S. Provisional Application No. 60/924,347, filed May 10, 2007, entitled “METHODS AND SYSTEMS FOR PROMPTING USERS OF COMPUTING DEVICES”; U.S. Provisional Application No. 60/924,575, filed May 21, 2007, entitled “METHODS AND SYSTEMS FOR PROMPTING USERS OF COMPUTING DEVICES”; U.S. Provisional Application No. 60/929,090, filed Jun. 12, 2007, entitled “SYSTEMS AND METHODS FOR ADVERTISING”; U.S. Provisional Application No. 60/929,463, filed Jun. 28, 2007, entitled “SYSTEMS AND METHODS FOR INFORMATION PRESENTATION”; and U.S. Provisional Application No. 60/929,618, filed Jul. 5, 2007, entitled “ADVERTISING INTERMEDIATION SERVER”, all of which are incorporated herein by reference in their entirety.

### TECHNICAL FIELD

This invention relates to reward based advertising systems.

### BACKGROUND OF THE INVENTION

Today, advertising is an important way for content providers on the internet to pay the costs of providing content. The real estate on the display screens of computers is very valuable. Currently, all of the screen real estate value gets transferred to advertising brokers. Computer users do not receive adequate payment for the use of their screen real estate. What is needed are systems and methods that accrue value to computer users, when computer users allow advertisements to be displayed on the display screens of their computing devices.

### BRIEF SUMMARY OF THE INVENTION

User information, such as an email address, is received at an advertising intermediation server from a computing device. The computing device is associated with a user. In response to receiving the user information, the advertising intermediation server prepares advertising information and scheduling information and sends the advertising information and scheduling information to the computing device. The advertising information can be a uniform resource locator that refers to an advertisement. The scheduling information can be a time interval such as fifteen minutes. Further, the advertising intermediation server accrues a reward on behalf of the user, the reward corresponding to the advertising information.

Other objects, features and advantages of the present invention will become apparent upon perusal of the following description in conjunction with the appended drawings.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 illustrates an exemplary advertising intermediation server in communication with a computing device.

FIG. 2 illustrates an exemplary method that can be executed on an advertising intermediation server.

### DESCRIPTION OF EMBODIMENTS

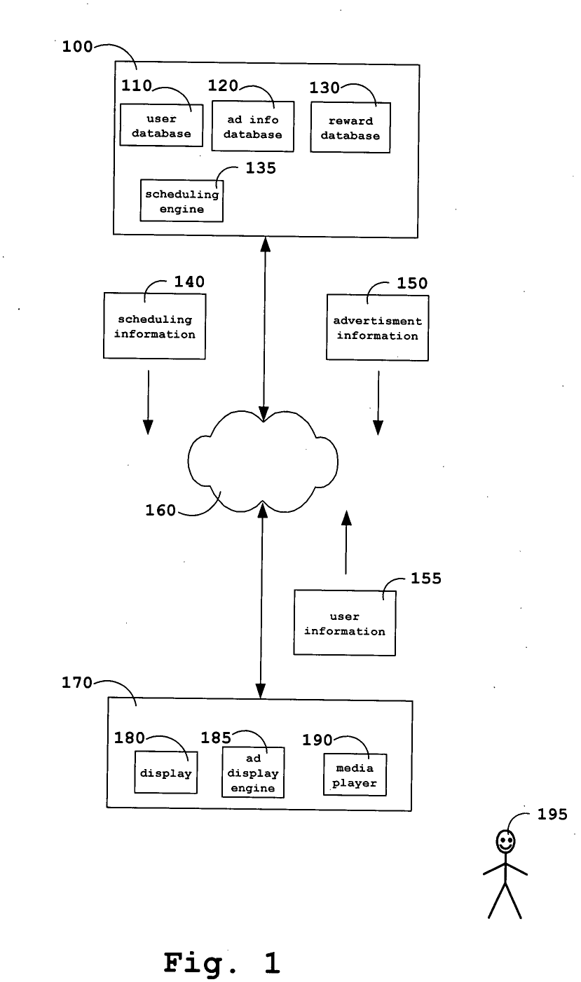

FIG. 1 illustrates an advertising reward system comprising an advertising intermediation server 100 and a computing device 170. The computing device 170 is associated with a user 195. The advertising intermediation server 100 is in communication with the computing device 170 via a network 160. The network 160 can be any suitable network such as the internet, wireless network and cellphone network.

The advertising intermediation server 100 can be implemented using one or more server computers. The advertising intermediation server 100 comprises a user database 110, advertisement information database 120, user reward database 130 and scheduling engine 135. The component modules that make up the advertising intermediation server 100 do not need to be located on the same computing device. For example, the user database 110 could be on a different computing device than the scheduling engine 135. The user database 110 can keep track of user information 155. User information 155 can include user details and demographics and login credentials and other data that correspond to the user 195. The advertisement information database 120 can keep track of advertisement information 150. Advertisement information 150 can include locations of videos, locations of banner ads, reward values for particular advertisements and any other information pertinent to advertisements. 130 is a user reward database that can be used to keep track of rewards accrued on behalf of the user 195. The scheduling engine 135 can prepare scheduling information 140 in order to meet scheduling goals desired by advertisers. The computing device 170 associated with the user 195, can have an associated display 180, an advertisement display engine 185 and a media player 190.

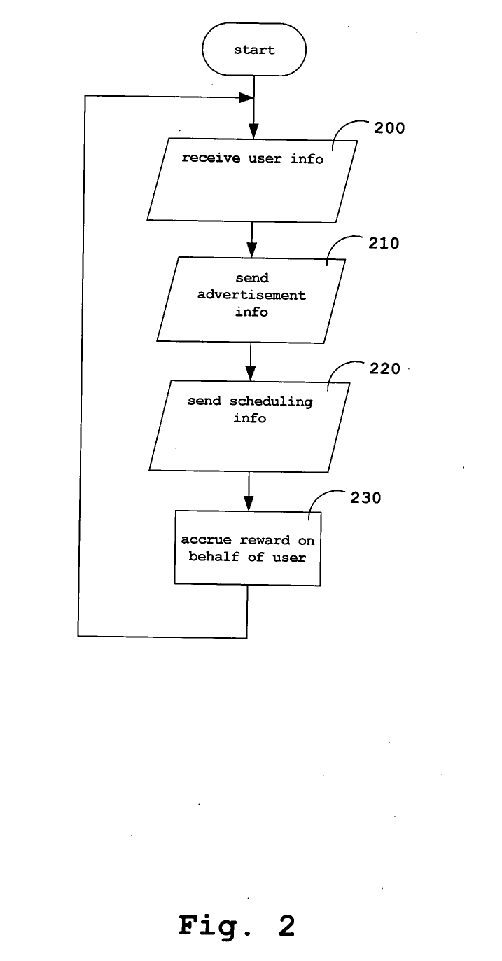

FIG. 2 illustrates a method that can be implemented by the advertising intermediation server 100. In block 200, the advertising intermediation server 100 receives user information 155 from the computing device 170 via the network 160. The user information 155 can travel through other computing devices and networks on its way from the computing device 170 to the advertising information server 100. The user information 155 can be an email address. Block 200 can be implemented as a web page responsive to an HTTP POST request and the user information 155 can be part of the HTTP POST request. The user information 155 received in block 200 can be checked against the user database 110 to ensure it is valid.

In block 210, advertisement information 150 can be sent to the computing device 170 as part of the reply to the HTTP POST request. The advertisement information 150 sent in block 210 can correspond to a uniform resource locator (URL) that refers to a banner ad or an advertising video. The computing device 170 can then use the URL to display an advertisement. Reward information can be included with the advertisement information 150, so that when an advertisement is displayed on the computing device 170, the reward accruing to the user 195 for the advertisement can be indicated.

In block 220, scheduling information 140 can also be sent to the computing device 170 as part of the reply to the HTTP POST request. Scheduling information 140 can be integer data such as the number five, number ten, number fifteen and number thirty—these can correspond to the number of minutes before the computing device 170 should request advertising information 150 again. Other examples of scheduling information 140 include specific times on particular days.

In block 230, the user reward database is updated to accrue an additional reward for the user 195 corresponding to the user information 155 identified in block 200 and the advertisement information 150 utilized in block 210. An example would be to make an entry in the user reward database 130 corresponding to $0.05, user 195 and advertisement information 150. Many other ways to accrue a reward on behalf of the user 195 are of course possible.

Many alternative embodiments to the above described systems and methods are possible. While various embodiments have been described above, it should be understood that they have been presented by way of example only and not limitation.

What is claimed is:

1. A method comprising:
receiving from a computing device, user information corresponding to a first user; and
in response to receiving the user information, sending advertisement information to the computing device;
sending scheduling information to the computing device; and
accruing a reward on behalf of the first user.
